(19) United States
(12) Patent Application Publication
(10) Pub. No.: US 2002/0011697 A1
(43) Pub. Date: Jan. 31, 2002

(54) Strut with an air-filled cushion

(76) Inventors: Christoph Pesch, Augustin (DE); Helmut Drees, Ennepetal (DE); Antonio Branco, Hamburg (DE); Rudiger Lorenz, Winsen (DE); Jens Schlittchen, Hamburg (DE)

Correspondence Address: Dr. Max Fogiel, 61 Ethel Road West, Piscataway, NJ, 08854, US

(21) Appl. No.: 09/916,086

(22) Filed: Jul. 26, 2001

(30) Foreign Application Priority Data
Jul. 29, 2000 (DE) 100 37 026. 8-12

(51) Int. Cl. F16F 9/04

(52) U.S. Cl. 267/64.23

(57) ABSTRACT

A strut with an air-filled cushion and comprising a bellows (1) that rolls down over a surface (3), a hydraulic dashpot accommodated inside the bellows or surface, a piston rod (5) that travels in and out of the dashpot, and an upper and lower closing and fastening component provided with seals, whereby the seals are O rings. The object is a simple approach to sealing the interface between the closing and fastening components and the dashpot that will still allow a reliable seal by means of O rings. Each O ring (9 & 10) is accordingly accommodated in a recess both radially and axially open at one side in the upper component, rests radially against the lower component, and is fixed and/or tensioned axially by a ring (14) fastened to the upper component or by a disk (12).

The present invention concerns a strut with an air-filled cushion as recited in the preamble to claim 1. Struts of this genus are being increasingly employed in wheel suspensions for smooth-riding vehicles. One such device is known from German 19 819 642 A1 for example. The cushion is essentially a bellows that rolls down, has closing and fastening components at one end and accommodates a hydraulic dashpot. The interface between the bellows and the dashpot must be sealed, and O rings accommodated in grooves have proven satisfactory for this purpose. The grooves have always been preferably machined into the closing and fastening components, a complicated procedure that causes considerable wear on the tools. Finally, since the closing and fastening components are preferably plastic, machining them often leads to strain and fissuring.

The object of the present invention is accordingly a simpler approach to sealing the interface between the closing and fastening components and the dashpot that will still allow a reliable seal by means of O rings.

This object is attained in accordance with the present invention by the characteristics recited in the body of claim 1. Advantageous and advanced embodiments are addressed in claims 2 through 4.

The particular advantage of the present invention is that the accommodations for the O rings are not machined, which avoids the aforesaid drawbacks. Another advantage is that one stage of the manufacturing process is eliminated, considerably simplifying it.

One embodiment of the present invention will now be specified with reference to the accompanying drawing, wherein

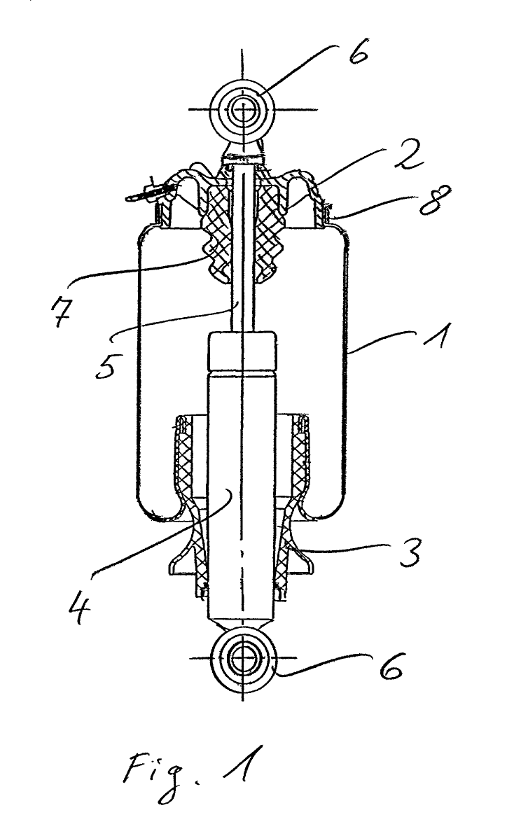

FIG. 1 is a schematic illustration of an strut with an air-filled cushion,

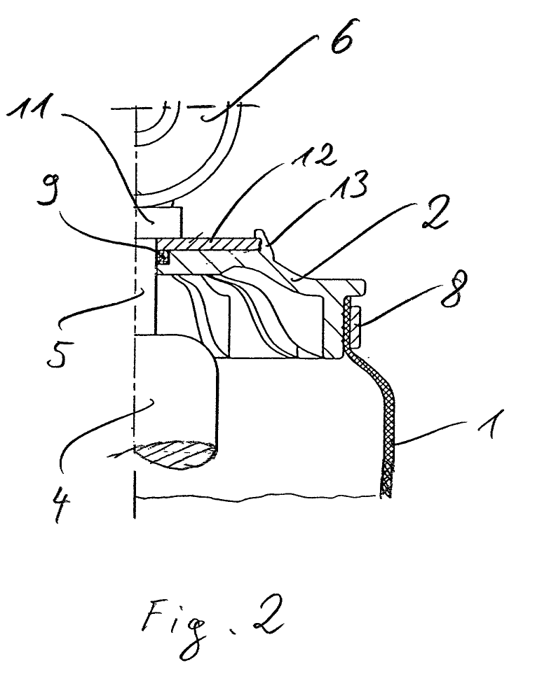

FIG. 2 is a larger-scale illustration of the interface between the upper fastening component and the piston rod,

and

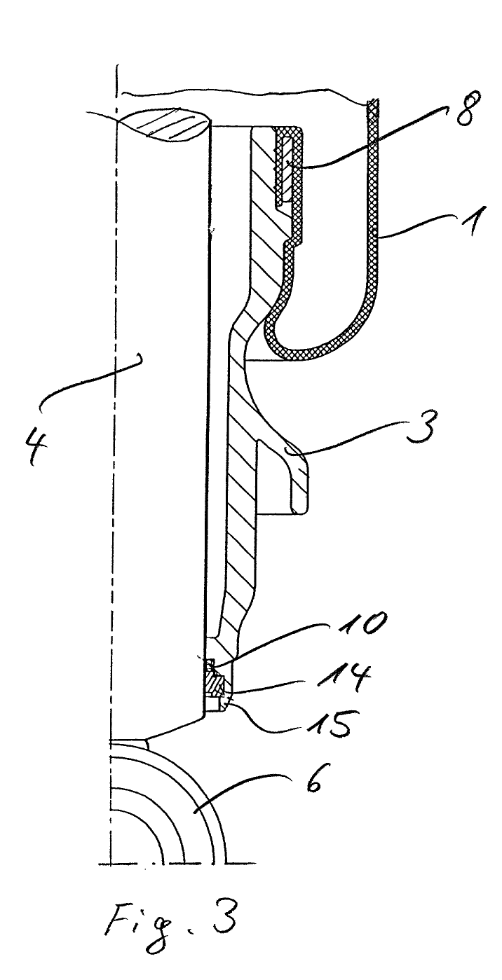

FIG. 3 is a larger-scale illustration of the interface between the lower fastening component, in the form of a surface that the bellows rolls down over, and the dashpot's cylinder.

The strut preferably consists of an air cushion with a hydraulic dashpot accommodated inside. As will be evident from FIG. 1, the cushion essential comprises a bellows 1 that rolls down and has closing and fastening components at each end. These components are represented in the present embodiment by a cap 2 at the top and by a surface 3 at the bottom that the bellows rolls down over. The dashpot consists of a shock-absorbing cylinder 4 and of a piston rod 5 that travels into and out of it. Cylinder 4 is secured at its upper end and piston rod 5 at its lower end to the vehicle's body or suspension by eyes 6.

Cap 2 and surface 3 are preferably plastic, which may be reinforced with glass fiber or another material. These components are injection molded.

An elastic compression-accommodating stop 7 is positioned below cap 2 and around piston rod 5. Stop 7 ensures that the rod will not be forced all the way through its potential stroke when subjected to a powerful impact, but will be resiliently braked.

As will be evident from FIGS. 2 and 3, bellows 1 is forced against and sealed off gas tight from cap 2 and surface 3 by tensioned bands 8, and cap 2 is sealed off gastight from piston rod 5 and from surface 3 and cylinder 4 by O rings 9 and 10.

As will be evident from the detail, FIG. 2, upper O ring 9 is accommodated in an axial recess in cap 2 that opens toward upper eye 6. The inner edge of O ring 9 rests against piston rod 5. The recess is dimensioned to deform the ring radially, resulting in tension that ensures a reliable seal.

The end of piston rod 5 next to eye 6 is provided with a collar 11 that accommodates cap 2. Between cap 2 and collar 11 is a disk 12 that closes off the recess axially. This arrangement tensions upper O ring 9 in that direction. Disk 12 is provided with at least one and preferably with several radial slits that divide it into segments. The disk is secured at its outside circumference by tensioned hooks or by an outer bead 13.

How the seal is assembled will now be specified. The air cushion and dashpot are fastened together, cap 2 positioned some distance below collar 11. Upper O ring 9 is inserted into the recess and disk 12 below bead 13 segment by segment. Cap 2 is slid against collar 11, permanently and reliably fixing it gas tight, axial fixation being ensured by the pressure inside the cushion.

Surface 3 is fastened to cylinder 4 as represented in FIG. 3. Lower O ring 10 is accommodated in the open recess in surface 3 and radially tensioned against the cylinder. Ring 10 is axially tensioned by a ring 14 that, like disk 12, includes at least one and preferably several radial slits that divide it into segments. Here as well, ring 14 is secured axially by tensioned hooks or by a bead 15 at the lower end of surface 3.

In one version of the strut that differs from the embodiment illustrated in FIG. 3, surface 3 or a similar closing and fastening component is not sealed off.

1. Strut with an air-filled cushion and comprising a bellows (1) that rolls down over a surface (3), a hydraulic dashpot accommodated inside the bellows or surface, a piston rod (5) that travels in and out of the dashpot, and an upper and lower closing and fastening component provided with seals, whereby the seals are O rings, characterized in that each O ring (9 & 10) is accommodated in a recess both radially and axially open at one side in the upper component, rests radially against the lower component, and is fixed and/or tensioned axially by a ring (14) fastened to the upper component or by a disk (12).

2. Strut as in claim 1, characterized in that the O-ring seal is between either the cylinder (4) or a spring support and the surface (3) that the bellows rolls down over.

3. Strut as in claim 1, characterized in that the O-ring seal is between the piston rod (5) and the upper closing and fastening component, which is in the form of a cap (2) fastened to the bellows (1).

4. Strut as in one of claims 1 through 3, characterized in that either the ring (14) that fixes the O-ring seal or a disk (12) has one or more radial slits and 1 engages, in the form of a snap-in fastening, a groove that 2 extends around the upper closing and fastening component.
